(19) United States
(12) Patent Application Publication
(10) Pub. No.: US 2020/0358856 A1
(43) Pub. Date: Nov. 12, 2020

(54) SMART LOGIN SESSION MANAGEMENT

(71) Applicant: SugarCRM Inc., Cupertino, CA (US)

(72) Inventors: Filipe Guerra, San Jose, CA (US); Vladyslav Kulchytskyy, Nashua, NH (US)

(21) Appl. No.: 15/230,465

(22) Filed: Aug. 7, 2016

(51) Int. Cl. H04L 29/08; H04W 76/19

(52) U.S. Cl. CPC H04L 67/143; H04W 76/19; H04L 67/146

(57) ABSTRACT

Embodiments of the present invention provide a method, system and computer program product for smart login session management. In an embodiment of the invention, a method of smart login session management includes authenticating an end user into a protected session of a Web application through a primary computing device and additionally authenticating the end user into a protected session of a mobile application of a secondary mobile computing device. The method further includes detecting a timeout condition in the protected session of the Web application for the end user. Finally, the method includes responding to the detection of the timeout condition by automatically logging the end user out of the protected session of the Web application if a timeout condition also exists in the protected session of the mobile application for the end user, but otherwise automatically renewing the protected session of the Web application.

### BACKGROUND OF THE INVENTION

### Field of the Invention

The present invention relates to application authentication and more particularly to managing log-in and log-out events in a computer program.

### Description of the Related Art

In Web based applications, the length of an active session can prove to be a security threat. The longer the length of an active session, the longer the application is exposed to a potential threat. Session timeouts describe the event in which the user is logged out automatically from a protected session of a Web application due to inactivity. The three categories of session timeouts include idle timeouts, absolute timeouts, and renewal timeouts. An idle timeout simply assigns an allowed time period for a user to be signed in and inactive before the session is terminated. Alternatively, an absolute timeout assigns an allowed time period for a session to be terminated, regardless of user activity. Renewal timeouts are more technical, in that they create a new identification for a user after a certain amount of time. This allows a user to stay logged into a protected session of a Web application but the user is at less of a security risk, as the identification and credentials to operate the protected session of the Web application change after a set amount of time for the user.

In order to understand session expirations, it is best to understand how sessions are started. A user must log into a protected session of a Web application where a unique session identification is created, as is a session file. These session identifications often are in the form of cookies. Idle timeouts are related to the cookies that are created and absolute timeouts are related to the session file. In an idle timeout when a cookie file indicates that a protected session of a Web application has been inactive for the amount of time designated by the protected session of the Web application, both session files are deleted, therefore ending the session. The process is the same for an absolute timeout but instead of the cookie file tracking timing, the session file is monitored and compared to an application designation. Thus, the core concept is based upon the reality that the shorter the amount of time a threat has to guess identification information that will allow session files to be created, the lower the risk the protected session of a Web application has of being infiltrated.

In order for an end user to automatically renew a protected session of a Web application without logging out first, the protected session of the Web application may utilize a renewal timeout. A renewal timeout simply creates new session files and automatically designates the user to the new session files and then deletes the old session files so that the end user technically remains logged into the protected session of the Web application, but the Web application then will be deceived into believing that there is a new user. A renewal timeout compliments, and works with both idle and absolute timeouts by allowing the end user to use a protected session of a Web application longer but with more security, as the identification of the end user constantly moves from session to session. This movement prevents sensitive information from being at the same place for long enough for a threat to infiltrate the protected session of the Web application.

In many organizations, the timeout period of a renewal timeout for a protected session of a Web application is dictated not by the convenience of the end user, but by a grander corporate policy intended to protect the organization as a whole from the consequence of too long an idle session in the protected session of the Web application. However, in not all instances is determined idleness in fact idleness. For example, while an end user may be present in proximity to a computing client through which the protected session of a Web application has been accessed and into which the end user has authenticated, the end user may be engaged in a telephone conversation so as to appear to be idle when in fact the end user is not idle. As well, while the end user may not engage in interactions with the protected session of a Web application, the end user may engage in interactions with another application concurrently executing in the same computing client—for instance when the end user composes a lengthy e-mail message. In these circumstances, the timeout period will lapse without interactivity in the protected application and an automatic logout will occur causing inconvenience to the end user.

### BRIEF SUMMARY OF THE INVENTION

Embodiments of the present invention address deficiencies of the art in respect to session management of a protected session of a Web application and provide a novel and non-obvious method, system and computer program product for smart login session management. In an embodiment of the invention, a method of smart login session management includes authenticating an end user into a protected session of a Web application through a primary computing device and additionally authenticating the end user into a protected session of a mobile application of a secondary mobile computing device. The method further includes detecting a timeout condition in the protected session of the Web application for the end user. Finally, the method includes responding to the detection of the timeout condition by automatically logging the end user out of the protected session of the Web application if a timeout condition also exists in the protected session of the mobile application for the end user, but otherwise automatically renewing the protected session of the Web application.

In one aspect of the embodiment, a prompt is generated in a display of the secondary mobile computing device prompting the end user to renew the protected session of the Web application in response to the detection of the timeout condition in the protected session of the Web application if the timeout condition does not also exist in the protected session of the mobile application. In another aspect of the embodiment, the protected session of the mobile application is determined not to be idle so long as user interface interactions are detected in the secondary mobile computing device, but a timeout condition in the protected session of the mobile application is determined to have arisen when a threshold period of time lapses during which no user interface interactions are detected in the secondary mobile computing device. In this regard, the user interface interactions include using a phone application in the secondary mobile computing device or using a media player in the secondary mobile computing device, to name two examples.

In another embodiment of the invention, a Web application data processing system is configured for smart login session management. The system includes a host computing platform with one or more computers, each with memory and at least one processor. The system also includes a Web application executing in the memory of the host computing platform and communicating with a Web application server over a computer communications network. Finally, the system includes a smart login session management module coupled to the Web application. The module includes program code enabled upon execution in the memory of the host computing platform to: (1) authenticate an end user into a protected session of the Web application, (2) establish a communicative linkage with a protected session for the end user in a mobile application executing in a secondary mobile computing device of the end user, (3) detect a timeout condition in the protected session of the Web application for the end user and (4) respond to the detection of the timeout condition, by determining if a timeout condition also exists in the protected session of a mobile application for the end user and automatically log out the end user from the protected session of the Web application if the timeout condition also exists in the protected session of the mobile application for the end user, but otherwise automatically renew the protected session of the Web application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for smart login session management;

FIG. 2 is a schematic illustration of a Web application data processing system configured for smart login session management; and,

FIG. 3 is a flow chart illustrating a process for smart login session management.

### DETAILED DESCRIPTION OF THE INVENTION

Embodiments of the invention provide for smart login session management. In accordance with an embodiment of the invention, an end user authenticates into a protected session of a Web application in a primary computing device. As well, the end user authenticates into a protected session of a mobile application in a secondary mobile computing device. A session timeout period is established for both the Web application in the primary computing device and also a session timeout period is established for the protected session of the mobile application. In response to a timeout condition arising in the protected session of the Web application, it is determined if a timeout condition also has occurred in the protected session of the mobile application. If so, the end user is automatically logged out of both sessions. But, if a timeout condition has not also occurred in the protected session of the mobile application, the end user is not automatically logged out from the protected session of the Web application and optionally, the protected session of the Web application is automatically renewed.

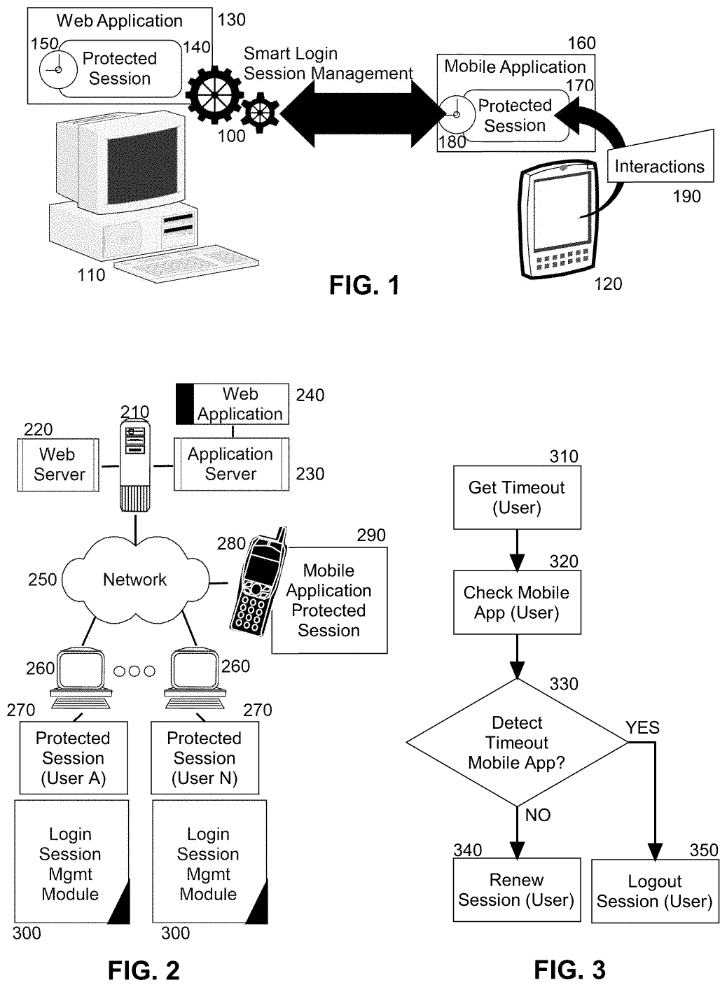

In further illustration, FIG. 1 pictorially shows a process for smart login session management. As shown in FIG. 1, a Web application 130 executes in the memory of a primary computing device 110. An end user authenticates into a protected session 140 of the Web application and a state of idleness results in a measurement of lapse of time during the state of idleness. When a threshold amount of time has elapsed in which the state of idleness persists in the protected session 140, a timeout condition 150 arises.

Smart login session management logic 100 detects the timeout condition 150 and, in response, detects whether a timeout condition 180 likewise exists in a protected session 170 for the same end user for a mobile application 160 executing in a secondary mobile computing device 120. In this regard, once the end user has authenticated into the protected session 170 of the mobile application 160, interactions 190 in the secondary mobile computing device 120, such as the use of a phone application in the secondary mobile computing device 120, or a media player of the secondary mobile computing device 120, or user interface events in the secondary mobile computing device 120, are sufficient to deter entry into a period of determined idleness. However, absence of the interactions 190 results in a period of determined idleness in response to a threshold duration of such determined idleness, a timeout condition 180 arises.

To the extent that the timeout conditions 150, 180 exist in both the primary computing device 110 and the secondary mobile computing device 120, smart login session management 100 logs out the end user from the protected session 140 of the Web application 130 thereby terminating the protected session 140. However, to the extent that no timeout condition 180 exists in the protected session 170 of the mobile application 160, despite the timeout condition 150 of the protected session 140 of the Web application 130, the protected session 140 is renewed automatically. Optionally, in a manual mode, rather than automatically renewing the protected session 140, a prompt instead is generated in a display of the secondary mobile computing device 120 requesting the end user to assent to the renewal of the protected session 140 of the Web application 130.

The process described in connection with FIG. 1 may be implemented in a Web application data processing system. In yet further illustration, FIG. 2 schematically shows a Web application data processing system configured for smart login session management. The system includes a server 210 that includes one or more computers, each with memory and at least one processor (only a single computer shown for ease of illustration). Both a Web server 220 and also an application server 230 execute in the memory of the server 210 so as to be able to support the operation of Web application 240.

Client computers 260 act as host computing platforms with one or more computers each with memory and at least one processor, and each of the computers 260 are communicatively coupled to the server 210 and support therein, different protected sessions 270 for different end users accessing the Web application 240. Each of the protected sessions 270 is coupled to a login session management module 300. The login session management module 300 includes program code that when executes in the memory of a corresponding one of the client computers 260, is enabled to respond to a timeout condition in a corresponding one of the protected sessions 270 for a corresponding end user.

The response by the program code of the login session management module 300 includes attempting to detect a timeout condition in connection with a protected session 290 of a mobile application executing in a secondary mobile computing device 280, such as a smart phone. The program code of the login session management module 300 when executing in the memory of a corresponding one of the protected sessions 270 then is enabled to automatically or manually renew the corresponding one of the protected sessions 270 if no corresponding timeout condition is detected in the protected session 290. But, otherwise, the program code of the login session management module 300 is enabled to log out the end user if a timeout condition exists in the protected session 290 for the end user as it does in the corresponding one of the protected sessions 270.

In yet further illustration of the operation of the login session management module 300, FIG. 3 is a flow chart illustrating a process for smart login session management. Beginning in block 310, a timeout condition is received for an end user in a protected session of a Web application in a primary computing device. In block 320, an attempt is made to detect a similar timeout condition in a protected session of a mobile application for the same end user in a secondary mobile computing device. In decision block 330, if both timeout conditions exist for the end user in the protected session of the Web application in the primary computing device as well as for the end user in the protected session of the mobile application in the secondary mobile computing device, in block 350 the end user is logged out of the protected session of the Web application. Otherwise, in block 340 the protected session of the Web application is renewed for the end user.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of smart login session management, the method comprising:
authenticating an end user into a protected session of a Web application through a primary computing device;
additionally authenticating the end user into a protected session of a mobile application of a secondary mobile computing device;
detecting a timeout condition in the protected session of the Web application for the end user; and,
responsive to the detection of the timeout condition, automatically logging the end user out of the protected session of the Web application if a timeout condition also exists in the protected session of the mobile application for the end user, but otherwise automatically renewing the protected session of the Web application.

2. The method of claim 1, wherein a prompt is generated in a display of the secondary mobile computing device prompting the end user to renew the protected session of the Web application in response to the detection of the timeout condition in the protected session of the Web application if the timeout condition does not also exist in the protected session of the mobile application.

3. The method of claim 1, wherein the protected session of the mobile application is determined not to be idle so long as user interface interactions are detected in the secondary mobile computing device, but a timeout condition in the protected session of the mobile application is determined to have arisen when a threshold period of time lapses during which no user interface interactions are detected in the secondary mobile computing device.

4. The method of claim 3, wherein the user interface interactions include using a phone application in the secondary mobile computing device.

5. The method of claim 3, wherein the user interface interactions include using a media player in the secondary mobile computing device.

6. A Web application data processing system configured for smart login session management, the system comprising:
a host computing platform comprising one or more computers, each with memory and at least one processor;
a Web application executing in the memory of the host computing platform and communicating with a Web application server over a computer communications network; and,
a smart login session management module coupled to the Web application, the module comprising program code enabled upon execution in the memory of the host computing platform to:
authenticate an end user into a protected session of the Web application,
establish a communicative linkage with a protected session for the end user in a mobile application executing in a secondary mobile computing device of the end user,
detect a timeout condition in the protected session of the Web application for the end user and
respond to the detection of the timeout condition, by determining if a timeout condition also exists in the protected session of a mobile application for the end user and automatically log out the end user from the protected session of the Web application if the timeout condition also exists in the protected session of the mobile application for the end user, but otherwise automatically renew the protected session of the Web application.

7. The system of claim 6, wherein a prompt is generated in a display of the secondary mobile computing device prompting the end user to renew the protected session of the Web application in response to the detection of the timeout condition in the protected session of the Web application if the timeout condition does not also exist in the protected session of the mobile application.

8. The system of claim 6, wherein the protected session of the mobile application is determined not to be idle so long as user interface interactions are detected in the secondary mobile computing device, but a timeout condition in the protected session of the mobile application is determined to have arisen when a threshold period of time lapses during which no user interface interactions are detected in the secondary mobile computing device.

9. The system of claim 8, wherein the user interface interactions include using a phone application in the secondary mobile computing device.

10. The system of claim 8, wherein the user interface interactions include using a media player in the secondary mobile computing device.

11. A computer program product for smart login session management, the computer program product comprising a computer readable storage medium having program instructions embodied therewith, the program instructions executable by a device to cause the device to perform a method comprising:
authenticating an end user into a protected session of a Web application through a primary computing device;
additionally authenticating the end user into a protected session of a mobile application of a secondary mobile computing device;
detecting a timeout condition in the protected session of the Web application for the end user; and,
responsive to the detection of the timeout condition, automatically logging the end user out of the protected session of the Web application if a timeout condition also exists in the protected session of the mobile application for the end user, but otherwise automatically renewing the protected session of the Web application.

12. The computer program product of claim 11, wherein a prompt is generated in a display of the secondary mobile computing device prompting the end user to renew the protected session of the Web application in response to the detection of the timeout condition in the protected session of the Web application if the timeout condition does not also exist in the protected session of the mobile application.

13. The computer program product of claim 11, wherein the protected session of the mobile application is determined not to be idle so long as user interface interactions are detected in the secondary mobile computing device, but a timeout condition in the protected session of the mobile application is determined to have arisen when a threshold period of time lapses during which no user interface interactions are detected in the secondary mobile computing device.

14. The computer program product of claim 13, wherein the user interface interactions include using a phone application in the secondary mobile computing device.

15. The computer program product of claim 13, wherein the user interface interactions include using a media player in the secondary mobile computing device.
